(19) United States
(12) Patent Application Publication
(10) Pub. No.: US 2002/0183443 A1
(43) Pub. Date: Dec. 5, 2002

(54) Methods and compositions for making water-borne dispersions

(75) Inventors: Tyler Housel, Lansdale, PA (US); Glenn Gleason, Deptford, NJ (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Inolex Investment Corporation, Wilmington, DE

(21) Appl. No.: 10/062,890

(22) Filed: Jan. 30, 2002

Related U.S. Application Data
(60) Provisional application No. 60/265,302, filed on Jan. 30, 2001.

(51) Int. Cl. C08L 75/04

(52) U.S. Cl. 524/591; 524/840; 252/182.28

(57) ABSTRACT

Dispersion-stable polymeric acid functional polyols and dispersions of such materials, a method for improving the long term storage dispersibility and hydrolytic resistance of an acid functional polyol and a method for making a water-borne polyurethane, as well as personal care and industrial lubricants, using such improved acid functional polymeric polyols are provided. The polymeric acid functional polyols are reaction products of reaction mixtures including a base polyol having at least one of a terminal secondary and/or tertiary hydroxyl group and an aromatic anhydride.

### CROSS REFERENCE TO RELATED APPLICATION

This patent application claims the benefit of provisional U.S. Patent Application No. 60/265,302, filed on Jan. 30, 2000, the disclosure of which is incorporated herein by reference.

### BACKGROUND OF THE INVENTION

Polyols are polyhydric alcohols, i.e., alcohols that contain two or more hydroxyl groups. Polyols are useful in a wide variety of industrial and commercial products and processes. For example, polyols are used in the manufacture of most polyurethanes, and provide useful and beneficial properties when incorporated into personal care and lubricant products.

Most common polyols, including those used in the conventional manufacture of polyurethanes, are low molecular weight polymers, such as polyethers, polyesters, polycarbonates, polyacrylics, melamine, and polybutadiene polyols. Such polyols are generally provided with two primary terminal hydroxyl groups, and may have further hydroxyls located randomly along the backbone.

These polyols generally have a low level of residual acid functionality. This low level of residual acid functionality can be attributed to the use of carboxylic acids, which incompletely react with diols in the formation of the polyol, during the manufacture of the polyols. For example, in manufacturing polyester polyols, the reactant carboxylic acids may provide a residual acid value of less than 10 mg KOH/gram, with the majority of polyester polyols having acid values less than 1.5. Other polyols generally have an acid value of less than 1. Because of the low levels of acid functionality of most polyols, they are generally more compatible with organic solvent-based dispersion systems, as opposed to the water based dispersion systems presently favored by many sectors of modern industry. Thus, polyols having low levels of acid functionality have restricted practical utility in the commercial context, particularly in view of growing awareness of the toxicity and pollution issues associated with the use of organic solvents.

Because polyols generally have a low acid functionality, and therefore poor compatibility with water-borne dispersion systems, there have been attempts to provide specific acid functionality to such polyols. For example, in the manufacture of polyurethanes, methods of preparing specific acid functional polyols for use in forming water-borne polyurethanes have been developed. One method of providing acid functionality is to incorporate carboxylic acid groups into the polymer backbone using dimethylolpropionic acid (DMPA). Generally, in the process of forming the polyurethane, DMPA is reacted with the starting polyol and a diisocyanate to form an isocyanate-terminated prepolymer. The prepolymer is prepared at a temperature that permits the reaction of the hydroxyl groups with excess isocyanate without consuming all of the acid groups. The resulting acid functional prepolymer can then be made into a water-borne polyurethane dispersion by neutralizing the acid groups, dispersing the neutralized prepolymer in water, and curing it with a diamine.

However, use of DMPA in the preparation of polyurethanes is not without technical and economic drawbacks. DMPA is a solid material having a high melting point, and exhibits limited solubility in polyols. Accordingly, use of DMPA in industrial scale processes requires additional steps that consume time, labor, and materials. For example, DMPA typically requires pre-dissolution in the polyol using solvent at high temperatures (over 100° C.). This extra process step increases the time required to run the process, thereby increasing processing costs. Use of DMPA often requires the use of an amount of organic solvent(s), which may have a negative environmental impact and incurs additional indirect costs, such as the expenditures associated with waste solvent disposal and maintenance of employee safety.

Additionally, polyurethanes formed by the DMPA process, as described above, often exhibit undesirable properties. Non-DMPA process polyurethanes contain urethane linkages that exhibit strong hydrogen bonding; consequently, they usually phase separate into what is referred to in the art as a “hard segment.” However, when using DMPA, the final polyurethanes have an acid group within a few carbons of the urethane linkages. The close proximity of the acid group interferes with hard segment formation by inhibiting the phase separation. As a result, the mechanical properties of the finished polyurethane may be degraded.

In the context of polyurethane production, other water-borne systems have been introduced that involve the use of water-dispersible isocyanates that allow the user to keep the isocyanate in an aqueous medium. Unfortunately, during storage, isocyanates generally react with water, so the dispersible isocyanate is generally not storage-stable for long periods of time. Further, chemically blocked isocyanate groups are ordinarily unblocked only at temperatures that may be unsuitable for use with plastic substrates, and which are difficult to achieve in many environments such as, for example, in a concrete coating process. A third potential drawback is that the isocyanate modification that allows for water dispersability may also cause the polyurethane formed to exhibit poor mechanical properties and undesirable water sensitivity when cured.

Other products that were developed to improve upon the DMPA process include products that react polyols with trimellitic anhydrides to provide an acid functional polyester polyol. Trimellitic anhydride has one anhydride group and serves to lower the average number of hydroxyl groups per molecule in most cases. Therefore, typically the hydroxyl functionality is significantly reduced. However, the resulting polyurethanes have a low molecular weight and produce coatings that are often too soft and/or weak to be of commercial use and may take on a yellow color upon exposure to ultraviolet rays, such as those present in sunlight.

Further improvements to the DMPA process described above have also been developed in which the starting polyols are reacted with mono- and polyanhydrides under reaction conditions that permit the reaction of the anhydride with the hydroxyl groups of the polyol, but are mild enough to prevent further reaction of the residual carboxylic acids with hydroxyl groups. In this way, production of acid functional polyols that have no reactive isocyanate groups, as in the aforementioned DMPA technology, is accomplished. These polyols can remain dispersed in water, along with performance enhancing additives, for an indefinite period of time. When the user undertakes to form the polyurethane, the aqueous polyol solution and isocyanate are combined. Generally, this liquid is applied to the desired substrate(s), and water evaporates while the polymer forms.

Use of this technology allows the formation of coatings, adhesives and other polyurethane articles with excellent mechanical properties in a water-borne system, but reduces or eliminates the use of traditional organic solvents. Commercial examples of this technology include LEXOREZ® 1405-65 and LEXOREZ® 4505-52, both available from Inolex Chemical Company, Inc., Philadelphia, Pa., U.S.A.

In addition to their use in the manufacture of polyurethanes, ester containing acid functional polyols can be used in products in which long term stability within a water-borne dispersion system is desirable, for example, personal care products or industrial lubricants—products which are frequently left on the shelf for long periods of time, and, when used, come in contact with the skin and/or mucous membranes and breathing environment of the end user, necessitating an avoidance of volatile and/or potentially toxic or irritating organic solvents.

Organic esters are commonly used in cosmetic products, personal care products, lubricants and industrial polymer products to impart properties of lubricity, tenacity, film-forming capacities, and polarity. Most biological systems are complex organizations of water, oils, polysaccharides, and protein, in combination with other combination with other compounds in significantly lesser amounts. Esters are inherently compatible with many biological structures, for example, skin and hair, because much of the chemistry of an animal's body is ester-based. Further, use of polymeric esters is rapidly becoming more popular because increasing molecular weight results in higher viscosity, more permanence, and allows formation of a better and more uniform surface layer.

It is not surprising, therefore, that natural and synthetic esters are common ingredients in numerous personal care formulations, such as cosmetics and personal hygiene products. Such esters are non-toxic, and may serve as moisturizers, emollients, barriers, thickeners, conditioners, lubricants, film formers, and cleansers within a given formulation. As a result of their diverse utility, esters are used in a wide variety of finished products, such as, for example, skin creams, lipsticks, hair and body shampoos, sun care products, shaving cream and foams, hair conditioners, bath and shower gels, or deodorants and antiperspirants.

Because many of the commercially available personal care products are water-based emulsions and dispersions, any ester components in the products are subject to storage in the presence of water for relatively long periods of time. Therefore, it is significant that the particular esters selected for use in these water-based products exhibit good hydrolytic stability, in order to avoid the unpleasant effects of ester degradation, such as phase separation, viscosity breakdown, development of unpleasant odors, and overall decrease in product performance.

However, use of conventional polymeric esters in this manner presents several difficulties. For example, polymeric esters are particularly sensitive to hydrolytic decomposition and the resultant depolymerization results in a loss of the properties for which the polymeric ester was originally selected. To avoid this, polymeric esters are frequently used in non-water based systems, but there remains a need for polymeric esters that can be used in water-based systems.

Dispersion-stable acid functional polyols (AFPs) would provide unique benefits for a variety of cosmetic products where shelf-stability is critical. The dispersion-stable AFPs could be used for cleansing, conditioning, moisturizing, sun care, or other products used on the skin or hair, and may provide, for example, emulsification properties or film forming properties to the finished product, or may serve to facilitate the topical delivery of active ingredients to a specified area. Products containing AFPs may take the form of, for example, a liquid, gel, suspension, emulsion, solid, lotion, or cream.

Functional additives for use in personal care products are often selected with the intent that the additive serves multiple purposes in a given formulation. A common example is in what are called “self emulsifying products.” The formulator selects the additive having both a desirable primary property and an emulsifying capability. In this manner, the formulator is able to obtain the primary benefit of the additive in the formulation, but also can formulate an emulsion in water without the use of additional additives that are emulsifiers. A commercial example of an additive having dual properties is a blend of simple esters sold under the trademark LEXEMUL® 561, Inolex Chemical Company, Philadelphia, Pa., U.S.A. The primary use of LEXEMUL® 561 is to improve the appearance and “skin feel” of the finished formulation, such as cosmetic creams and lotions. This product additionally can be used as a primary oil-in-water emulsifier in both ionic and non-ionic systems over a broad pH range. While it is valued in the industry for its combined properties, it is non-polymeric, and therefore does not provide the film-forming, thickening, barrier and targeted delivery benefits that a polymeric ester can provide. Dispersion-stable AFPs for use in personal care products or industrial lubricants that could be formulated to function in this manner are desirable.

Esters are also commonly used in the lubricant industry. Fats and oils of both animal and vegetable origin have been used throughout history to reduce friction. In modern times, synthetic esters have been designed to modify and improve on the benefits offered by conventional fats and oils, and to provide better cleanliness, lubricity, stability, and other properties when compared to similar natural materials. Water is often added to lubricant formulations to provide cooling and/or cleaning functions, or to act as an inexpensive medium for reducing viscosity or a carrier for active lubricant ingredients such as esters. Particular examples of water-based industrial lubricants are fluids for cutting, grinding, forming, or otherwise machining hard materials such as metals. These lubricants are collectively referred to as “metalworking fluids,” although they are often used in the machining of stone, glass, ceramics, plastics, wood, and other non-metallic materials. In these lubricant products, the fluid serves to reduce friction, cool the machined parts, carry away debris, and can leave a protective barrier on the freshly-machined surface. An appropriately chosen lubrication fluid can increase tool life, improve surface finish, and increase the energy efficiency of the machining process.

Water is an ideal solvent for such lubricant products because it is inexpensive and provides excellent cooling, without causing a fire hazard. However, water alone is not useful as a lubricant, and can increase corrosion of many materials if the appropriate additives are not included. Aqueous emulsified esters and polymeric esters are often used in metalworking fluids to provide benefits in lubricity, surface finish, corrosion resistance, and efficiency to the system. Polymeric esters in particular have shown a significant increase in performance in the extreme pressure lubrication regime. However, it is known that hydrolytic and biological degradation of esters can lead to toxicity, scum, and odor, and can compromise the performance of aqueous lubrication fluids. Often these fluids must be replaced when the dispersed ester is degraded, so an ester which degrades quickly will lead to increased waste disposal requirements, increased downtime, and associated cost and environmental issues. Therefore, hydrolysis resistant and dispersion-stable esters would be particularly desirable for use in water-based metalworking fluids.

Most water-based lubricant ester emulsions are achieved by adding non-ester emulsifiers to the system. These external emulsifiers give rise to a wide variety of problems, including undesirable surface competition, odor, skin dermatitis in exposed workers, additive incompatibility, and staining of exposed metal. Dispersion-stable AFPs capable of forming a dispersion without external emulsifiers, and which remain stable so they can be used in conventional lubrication systems, where the lubrication fluid is recycled and reused over a long period of time would be particularly desirable.

Acid functional polyols are also disclosed in U.S. Pat. Nos. 5,880,250 and 6,103,822, the contents of each of which are incorporated herein by reference. Some of these materials are polyester polyols with a typical acid value of 60, a typical hydroxyl number of 65, and a hydroxyl functionality of less than or equal to 2 and which can be used to form polyurethanes. These polyester polyols are formed from esterified polyols, polyacids, and aliphatic anhydrides. The resulting polyols are a significant improvement over previous technology. However, they remain unsuitable for some commercial water-borne polyurethane applications because of their limited dispersion stability during long-term storage. This limited dispersion stability is thought to be caused by hydrolysis of the acid functional polyol, and it can be observed indirectly, for example, through decreases in dispersability, decreasing viscosity, decreasing pH. These changes in physical properties present an obstacle to some commercial applications of such polyol-containing products, since the resulting modifications of properties poses problems for the end user, who must repeatedly adjust his or her formulations as the dispersion ages in order to obtain satisfactory product performance.

Therefore, there is a need in the art for acid functional polyols having the unique manufacturing advantages of acid functional polyols such as LEXOREZ® 1405-65 and LEXOREZ® 4505-52, but which exhibit improved dispersion stability for long term storage. There is further a need in the art for a method for improving the dispersion stability of AFPs generally over time. Conventional AFPs do not provide sufficient storage stability such that they can be used in the lubricant or cosmetic industries, where dispersed polymers are incorporated into retail and industrial products that are stored for a relatively long period of time before use, or are reused. Thus, there is further a need in the art for AFPs with improved dispersion stability that can be used for water-based lubricants, personal care products, and in the preparation of polyurethanes.

### BRIEF SUMMARY OF THE INVENTION

The invention includes a dispersion-stable polymeric acid functional polyol that is the reaction product of a reaction mixture. The mixture comprises a base polyol that has at least on eof a terminal secondary and/or tertiary hydroxyl group, and an aromatic anhydride, wherein the polymeric acid functional polyol exhibits improved dispersion stability and is resistant to hydrolysis.

Also included within the invention is a storage stable acid functional polyol dispersion, comprising an acid functional polymeric polyol which is the reaction product of a reaction mixture comprising a base polyol having at least one of a terminal secondary and/or tertiary hydroxyl group and an aromatic anhydride, wherein the acid functional polymeric polyol is dispersed by neutralizing at least one pendant carboxylic acid functional group on the acid functional polymeric polyol.

A solid polymeric material is also part of the invention. This solid material is formed from the curing reaction of an acid functional polymeric polyol, wherein the acid functional polyol is the reaction product of a reaction mixture comprising a base polyol having at least one of a terminal secondary and/or tertiary hydroxyl group and an aromatic anhydride.

The invention additionally includes a method for improving the long term storage dispersibility and hydrolytic resistance of an acid functional polyol. The method comprises forming the acid functional polyol from the reaction of a base polyol having at least one of a terminal secondary and/or tertiary hydroxyl group and an aromatic anhydride.

In one embodiment, the invention encompasses a method for making a water-borne polyurethane, comprising reaction of a polyisocyanate and an acid functional polyol dispersion, wherein the dispersion comprises an acid functional polyol formed from the reaction of a base polyol having at least one of a terminal secondary and/or tertiary hydroxyl group and an aromatic anhydride.

In a further embodiment, the invention includes a personal care and/or industrial lubricant formulation comprising an acid functional polymeric polyol formed from the reaction of a base polyol at least one of a terminal secondary and/or tertiary hydroxyl group and an aromatic anhydride. The personal care formulation comprises a dispersion-stable polymeric acid functional polyol, wherein the dispersion-stable polymeric acid functional polyol is formed from the reaction of a base polyol having at least one of a terminal secondary and/or tertiary hydroxyl group and an aromatic anhydride.

### DETAILED DESCRIPTION OF THE INVENTION

The present invention improves the problems encountered in making commercial formulations with prior art polyols by providing dispersion-stable polymeric acid functional polyols, storage stable acid functional polyol dispersions, a method for improving the long term storage dispersibility and hydrolytic resistance of acid functional polyols, and a method for making a water-borne polyurethane using such improved, long term storage stable acid functional polyols. The improved acid functional polyols exhibit improved dispersion stability, while maintaining the previously stated benefits of this prior art acid functional polyols such as LEXOREZ® 1405-65 and LEXOREZ® 4505-52. The invention includes an acid functional polymeric polyol that contains not only reactive hydroxyl sites, but also reactive or neutralizable carboxylic acid sites, which are distributed throughout the polymer backbone.

The present invention is directed to such polymeric acid functional polyols (AFPs), useful for forming water-borne polyurethanes that have longer dispersion stability than available using the prior art technology. As used herein, the term “polyol” means a monomeric or polymeric alcohol that has at least one hydroxyl group, but preferably has at least two such groups, one of which is preferably a terminal secondary hydroxyl group. “Polyanhydride” and “polyisocyanate,” as used herein refer, respectively to compounds having at least two or more anhydride or isocyanate groups.

In addition, as used herein, “acid value” or “acid number” of an acid functional polyol is determined by weighing a small sample, typically 2-10 grams, of the AFP into a flask. A 1:1 mixture of ethanol and benzene is added to dissolve the polyol. If the resin does not readily dissolve, a small amount of acetone may be added. The solution is titrated with a standardized solution of KOH and measured in units of mg KOH/g sample.

As used herein, the “hydroxyl value” or “hydroxyl number” of a given polymeric polyol is calculated by the following formula:

hydroxyl number=56,100/equivalent weight

wherein the equivalent weight is the hydroxyl equivalent weight.

Acid functional polyols according to the present invention having the preferred acid and hydroxyl values as noted below can be derived from a reaction of mono- or polyanhydrides, preferably aromatic mono- or polyanhydrides, with at least one polyol. The polyol(s) is preferably one which includes at least one terminal secondary and/or tertiary hydroxyl group, preferably at least one terminal secondary hydroxyl group, and/or that is di-hydroxy functional. The resulting acid functional polyol will have both reactive hydroxyl and neutralizable carboxylic acid groups in the polymer chain. Additional reactive or non-reactive chemicals may also be present in the finished composition within the scope and spirit of the invention. Further, the AFP of the invention can be dispersed in water by using an inorganic or organic base, such as an organic or inorganic amine or mineral base, to neutralize the acid groups.

The improved AFPs of the invention can be used in compositions to formulate dispersions that exhibit improved stability when stored in the dispersed state. Further, if it is desired to form a solid polymer from the dispersion, the solid polymer formed upon cure of such materials may have better application and/or mechanical properties.

The hydroxyl groups on the polymeric acid functional polyols can be reacted with polyisocyanates to yield carboxylic acid functional, preferably water-borne, polyurethanes in which the pendant carboxylic acid groups are compatible with water and do not interfere with formation of the hard segment of the polyurethane. As such, the polymeric acid functional polyols of the invention are especially useful for forming water-borne polyurethanes and hydrophilic polyurethane foams.

The polymeric acid functional polyols (AFPs) of the invention may also be combined with other reactive species to form solid polymers. Such solid polymers may be formed by subjecting the polymeric AFPs of the invention to a curing reaction. Such curing reaction may be a radiation cure or be accomplished by reaction of the polymeric AFPs of the invention with a curative, such as, for example, an isocyanate, an epoxide, an amine, or an oxirane, or by any other suitable cure mechanism(s) or combination of two or more cure mechanisms known in the art or to be developed for forming solid polymers from AFPs.

The invention also includes storage-stable acid functional polyol dispersions incorporating the dispersion-stable acid functional polyols of the invention. In addition to the polymeric AFPs, such dispersions may include water and a dispersing base. The dispersing base serves to neutralize the acid groups on the polyol, thereby facilitating dispersion of the AFP within the dispersion. The dispersions may also include other additives, reactive or non-reactive, that will impart specific properties to the final dispersion. Suitable additives may include, for example, catalysts, UV curing agents, colorants, thixotropic agents, pigments, leveling agents, UV stabilizers, corrosion inhibitors, emollients, odorants, dyes, biocides, fungicides, and surfactants. Monomers or oligomers may be incorporated in the dispersion to be later polymerized with the curing mechanisms described previously. Such monomers and/oligomers may be hydroxyl or amine functional and cure along with the hydroxyl groups of the AFP, as in an isocyanate cure, or have separate reactive mechanisms, such as an ethylenically unsaturated monomer or oligomer may cure with a UV or free-radical curing agent. Depending on the particular additives and/or other components present in the dispersion, the polymeric AFPs of the invention can be prepared to serve multiple functions within the dispersion, such as, for example, to act as an emulsifier or as a dispersing agent.

The dispersions of the invention can be formulated to be personal care formulations, such as cosmetic formulations, including, e.g., lipstick, face makeup, eye makeup, and other cosmetics, moisturizing creams, gels and lotions, and hair styling products, and personal hygiene formulations, such as soaps, bath and shower gels and washes, hair and body shampoos, conditioners, and other cleansers.

Additionally, the dispersions of the inventions can be used in the preparation of industrial lubricants, such as those used in processes for the machining of various materials, including the machining of metals, such as aluminum metals and ferrous metals, ceramics, glass, wood, and polymers.

In accordance with the invention, polymers can be formed from the reaction of such aqueous-based dispersions of the AFPs with other reactive chemicals. These can include the reaction with polyisocyanates to form urethanes, such as water-borne polyurethanes, oxiranes to form epoxy polymers, amines to form polyamides, and unsaturates to form radiation-curable systems, or many other such chemistries that can increase molecular weight of the AFPs in dispersion or by curing reaction to form useful cured parts or other polymers.

The applicants have discovered and demonstrated that an improvement of the present invention is its ability to form an aqueous polyol dispersion using the improved AFPs that can be stored for an extended period of time while maintaining lubrication and/or personal care product benefits, or the ability to form a useful solid polymer when appropriately cured, depending on the finished product into which they have been incorporated. A further improvement of the invention is that a dispersion of the AFPs of the invention maintains a more stable pH and viscosity so that one using the dispersion in the manufacture of a polyurethane may make fewer adjustments to the mixing and application processes based on viscosity changes caused by age and degree of degradation of the AFP. Such property improvements provide significant benefits, because the mechanical properties of the resultant solid polymer are more consistent and less affected by the age and state of the dispersion system prior to the application. Alternatively, if the AFPs are incorporated in a personal care product or a lubricant, the invention offers the advantage that the user will experience minimal degradation of product quality over time.

Dispersions of prior art acid functional polyols typically coalesce in a relatively short amount of time as water reacts with ester bonds in the acid functional polyols in storage, thereby depolymerizing the acid functional polyol by hydrolysis. This hydrolysis process is associated with a rapid decrease in viscosity and can also be implied by a decrease in pH as carboxylic acid groups are formed during hydrolysis of the ester bonds. Without wishing to be bound by theory, it is not believed possible to form infinitely stable aqueous polyol dispersions. However, the applicants have improved the dispersion stability by developing systems that are more resistant to hydrolysis and are also less sensitive to the hydrolytic degradation and depolymerization that ultimately occurs.

The present invention includes a polymeric acid functional polyol, which is a reaction product of (i) at least one base polyol and (ii) a mono- or polyanhydride or blend thereof. The base polyols may be monomeric or polymeric in nature. The at least one base polyol may have at least one of a terminal secondary and/or tertiary hydroxyl group. The one or more selected base polyol may be di-hydroxy functional. It is further preferred that the anhydride is a polyanhydride, and is preferably aromatic.

The polyols and anhydrides stated previously are particularly chosen to provide improved dispersion stability through improved resistance to hydrolysis and/or reduced sensitivity to the degradation that is thermodynamically required.

The applicants believe, without wishing to be bound by theory, that hydrolysis primarily occurs at the bond that forms between the anhydride and the polyol. For this reason, the applicants have discovered that it is beneficial and preferred to use base polyols in accordance with the invention that have secondary and/or tertiary hydroxyl groups in order to form hydrolysis-resistant bonds with the anhydride.

The applicants have discovered that there are two distinct factors that influence storage stability of the aqueous AFP dispersions. One is the rate of depolymerization that occurs when ester-containing polymers are stored in the presence of water as noted above. An ester is formed by reacting an acid and a hydroxyl group, or alternatively, by reacting a hydroxyl group with a carboxylic acid anhydride. In the first case, water is a byproduct. To form ester in a high yield, water must be aggressively driven off because the thermodynamic equilibrium constant, K, does not sufficiently favor the products (see formula (II) below).

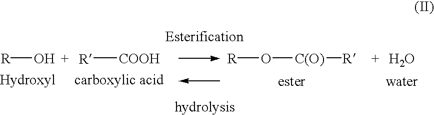

wherein the equilibrium constant K is expressed in terms of the bracketed concentrations of the above reactants as follows:

K=[ester][water]/[hydroxyl][carboxylic acid]

Because K is not large, and because an aqueous dispersion has a tremendous molar excess of water, the equilibrium of this system will tend to drive it back to the reactants. All ester systems will do this, but the equilibration rate will differ; hence the importance of forming an AFP that has relatively stable ester groups. As reactants reform, both the pH and viscosity will decrease. The pH decreases because carboxylic acid species are formed through the hydrolysis reaction, and viscosity decreases because the polymer molecular weight is also decreasing.

The second important criteria applicants have identified as relevant to determining the stability of aqueous dispersions of AFPs is the tendency for the particular AFP to remain dispersed as the system hydrolyzes. Assuming that pH values accurately reflect the evolution of carboxylic acid species, the change in pH serves as an indicator of the rate of hydrolysis. Some more storage-stable systems can remain dispersed as pH drops several units, while others will phase separate after a significantly smaller change in pH.

Therefore, the invention is directed to dispersion-stable AFPs and methods for improving the long term storage dispersibility and hydrolytic resistance of an AFP to achieve better dispersion stability. The base polyols are selected, in combination with preferred anhydrides, to form polymers that are more resistant to hydrolysis and which also remain dispersed in spite of the natural hydrolysis that thermodynamically must occur.

The AFPs of the invention preferably have an acid number of about 10 to about 300, more preferably of about 5 to about 200, and most preferably of about 10 to about 100, and a hydroxyl number of about 10 to about 500, more preferably from about 10 to about 300, and most preferably from about 10 to 200. The AFPs should be formed, and the reactants for forming the AFPs selected with, an emphasis on components and processing parameters that aid in imparting dispersion stability to the system. The AFPs are formed from the reaction of a base polyol with a mono- or polycarboxcylic acid anhydride. The following sections describe the desirable properties of each these raw materials.

The base polyol preferably has a hydroxyl number between of about 50 to about 1000, preferably of about 60 to about 200, and most preferably of about 100 to about 200. The hydroxyl functionality of the base polyol is about 1 to about 5 and preferably about 2. The base polyol(s) may be monomeric or polymeric in nature. Further, the base polyol(s) may be of an ester-type or of a non-ester type. Ester types may be formed from the reaction of one or more diacids and one or more monomeric or oligomeric diols. The diacid(s) may be any suitable diacid capable of forming an ester-based polyol which preferably has a secondary terminal hydroxyl group. Preferred diacids are described below. The diol may be any primary, secondary, or tertiary diol capable of reacting with a diacid to form an ester base polyol that has a secondary or tertiary terminal hydroxyl group. Such ester-type base polyols should provide a secondary and/or tertiary hydroxyl(s) to the ester base polyol in accordance with the invention as described further herein. Non-ester type base polyols include those such as polypropylene glycol, polycarbonate, polytetramethylene glycol, or other polymeric or monomeric polyols as described further below.

Suitable backbones for polymeric base polyols include polycarbonates, polyethers, polyesters, polyetheresters, polyacrylates, polybutadienes, polyalkylene and other backbones, wherein such backbones are hydroxy functional as noted herein.

Preferably the base polyol has the following formula (I) including at least one of a terminal secondary and/or tertiary hydroxyl group

HO—C(R¹)ₙ(R²)ₘR³OH (I)

wherein R¹ may be a hydrogen atom; R² may be a substituted or unsubstituted and branched or straight chain aliphatic alkyl and alkoxy groups of from 1 to 20 carbon atoms, including lower alkyl and longer chain species such as methyl, methoxy, ethyl, ethoxy, propyl, propoxy, butyl, butoxy, and the like; substituted or unsubstituted cycloaliphatic groups, such as cyclohexyl groups or similar species; substituted or unsubstituted aryl groups, such as benzyl, tolyl, xylyl, phthalic and the like; substituted or unsubstituted aralkyl groups, such as methyltolyl and similar species. R may be a substituted or unsubstituted aliphatic alkyl or alkoxy group of from 1 to 20 carbon atoms, or a cycloaliphatic group such as those species noted above, or a polymeric ether, a polymeric ester, or a polymeric ether ester, polycarbonate, or similar polymer species. In formula (I), n is 0 or 1, and m is 1 or 2. Substituted R¹, R², or R³ groups may include one or more of the following exemplary moieties: halogen, carbamate, amine, lower alkyl, carboxylic acid, and hydroxyl. It is preferred that, if R is substituted with a hydroxyl group, there is at least one such hydroxyl group in the secondary or tertiary terminal position with respect to the carbon in R which is adjacent the end hydroxy group of formula (I).

Many of the aforementioned polymeric polyol types have little tendency to hydrolyze. If the selected base polyol is a polymeric type including an ester, the ester bonds should be resistant to hydrolysis to provide for a particularly dispersion-stable AFP. Suitable monomeric polyols include, for example, 2,2,4-trimethyl-1,3-pentane diol (TMPD), 2-butyl-2-ethyl-1,3-propanediol (BEPD), 2,2-diemthyl-1,3-propanediol (neopentyl glycol) (NPG), 1,6-hexanediol (hexamethylene glycol) (HD), ethylene glycol (EG), 1,3-butanediol (1,3 BD), 1,4-butanediol (1,4-BD), diethylene glycol (DEG), propylene glycol (PG), dipropylene glycol (DPG), hydroxypivalyl hydroxypivalate (HPHP), 2-ethyl-2-(hydroxymethyl)-1,3-propanediol (trimethylol propane) (TMP), and cycloaliphatic diols. Preferably, a polymeric base polyol or monomeric base polyol is selected which has at least one of a terminal secondary and/or tertiary hydroxyl group, including polyethers, polyesters, polyalkylene glycols, 1,3 BD, PG, DPG, TMPD and the like, or combinations of such compounds with each other or with any other suitable primary, terminal hydroxyl group containing polyol such as BEPD, HD, NPG, HPHP, EG, DEG, and TMP.

In forming an ester base polyol, polyols are reacted with diacids as noted above and the reaction mixture further includes carboxylic acids or the anhydrides thereof. Suitable diacids for ester base polyol formation include adipic acid, azelaic acid, phthalic acid, orthophthalic acid, hexanedioic, isophthalic acid and cycloaliphatic acids such as 1,4-cyclohexane diacid (CHDA), and other diacids, such as dimer-based di- or polyacids which may be added on their own to the mixture or reacted first with polyols as noted above to form polymeric ester-type base polyols. Most preferred diacids include adipic acid, cyclohexane diacid and anhydrides and derivatives of these materials.

Further, the base polyol may be an ester polyol that is the reaction product of at least one polyol having at least one of a terminal secondary and/or tertiary hydroxyl group, optionally primary polyols, and a mono- or polycarboxylic acid or anhydride. Suitable polyols having a terminal secondary or tertiary hydroxyl group include PG, TMPD, DPG, 1,3 BD cyclodexane diol and the like. Suitable optional primary polyols include EG, DEG, BD, HD, NPG, BEPD, HPHP, TMP and the like. Suitable mono- or polycarboxylic acids or mono- or polycarboxylic anhydrides include adipic acid, azelaic acid, glutaric acid, cyclohexane diacid, phthalic acids and the anhydrides made therefrom.

The anhydrides used in the invention may be an aliphatic or aromatic; aromatic anhydrides are preferred. They may also be mono- or polycarboxylic anhydrides. Such materials are preferably selected to provide improved dispersion stability. Examples of useful, preferred anhydrides include 1,2,4-benzene tricarboxylic acid (trimellitic anhydride) (TMA), 1,2,4,5-benzene tetracarboxylic anhydride (pyromellitic dianhydride) (PMDA), hexahydrophthalic anhydride (cyclohexane dicarboxylic anhydride) (HHPA), and (2,5-dioxotetrahydrol)-3-methyl 3-cyclohexene-1,2 dicarboxylic anhydride (BAN), and any other mono- or polyanhydrides that are found to have beneficial dispersion stability properties. While some anhydrides are known to form bonds that are particularly resistant to hydrolysis, they are not necessarily useful for forming excellent dispersions. Therefore it is a combination of hydrolytic stability and dispersibility that is needed to produce a dispersion-stable AFP. As such, the above-noted aromatic anhydrides are preferred. It should be understood based on this disclosure that the appropriate anhydride for use in the present invention can be selected depending on the specific properties desired and the application(s) of the final reaction product AFP.

The invention herein also includes a storage-stable acid functional polyol dispersion. This dispersion comprises an acid functional polymeric polyol which is a reaction product of a reaction mixture that comprises a base polyol having a terminal secondary hydroxyl group and an aromatic anhydride. The acid functional polymeric polyol is dispersed within the dispersion by neutralizing at least one pendant carboxylic acid functional group contained on the acid functional polymeric polyol. The functional group can be neutralized by any means known in the art including by use of an organic or an inorganic amine, such as, for example, ammonia, mono-, di-, and trimethyl amine, mono-, di-, and trimethanolamine, mono-, di-, and triethyl amine, mono-, di-, and triethanolamine, other various mono-, di, and trialkyl amines, cyclic amines such as pyridines, piperazines, morpholines, and any other organic amines capable of neutralizing such end groups.

The invention also describes a formulation comprising the dispersion-stable polymeric acid functional polyol(s) as described above, specifically, formed from the reaction of a base polyol having at least one of a terminal secondary and/or tertiary hydroxyl group and an aromatic anhydride. The formulation comprising the dispersion stable polymeric acid functional polyol of the invention may be a personal care formulation, such as a cosmetic formulation or a personal hygiene formulation, or it may be a lubricant formulation. To prepare such formulations, the AFPs of the invention may be incorporated into conventional personal care or lubricant formulations, such as is disclosed in examples 5 to 9 herein.

Additionally, the invention is directed to a lubricant formulation comprising the dispersion stable polymeric acid functional polyol(s) of the invention. This lubricant formulation may be formulated for use in machine processing by the addition of any additives known in the art, such as, water, amines or other neutralizing agents, acids, performance additives, antioxidants, biocides, fungicides, colorants, odorants, lubricant oils, silicones, emulsifiers, and defoamers. In particular, the lubricant formulation is useful in the preparation of an industrial lubricant formulation for use in the preparation of lubricant formulations for use in the machine processing of metal, ceramic, glass, wood, and polymers.

The components described above may be combined and reacted using any of the techniques known in the art, noted herein, and/or described in U.S. Pat. Nos. 6,103,822 and 5,880,250, each of which are incorporated herein by reference.

The invention will now be described with respect to the following non-limiting examples:

### EXAMPLE 1

In each of the following Examples 1 to 4, the experimental procedure for forming the AFP was to first obtain a base polyol that was manufactured using standard procedures, see, e.g., Ortel, ed., The Polyurethane Handbook, 2nd ed., Hanger Gardner Publications, 1993, the contents of which are incorporated herein by reference.

Commercial materials used in the Examples include materials sold under the trademark LEXOREZ® 1400-120 (a 120 hydroxyl value polyester polyol from Inolex Chemical Company, Philadelphia, Pa., U.S.A.), CAPA 205 (a 135 hydroxyl value polycaprolactone polyol from Solvay, Houston, Tex., U.S.A.), Poly-G 26-150 (a 150 hydroxyl value polypropylene glycol polyol from Arch Chemicals, Norwalk, Conn., U.S.A.), CD208PL (134 hydroxyl value polycarbonate polyol from Daicel, Fort Lee, N.J., U.S.A.), and QO Polymeg 650 and 1000 (which are, respectively, a 180 hydroxyl value polytetramethylene glycol polyol and a 110 hydroxyl value polytetramethylene glycol polyol from Penn Specialty, Conshohocken, Pa., U.S.A.).

The base polyol was heated in a reaction vessel under dry conditions, and to the base polyol was added the specified amount of mono- or polyanhydride(s) pure or in blends as noted below. The reaction was allowed to proceed under temperatures and mixing conditions severe enough to allow the anhydride groups to react with hydroxyl groups in the base polyol, but mild enough to limit the degree of esterification to occur between the hydroxyl groups and the resultant carboxylic acid groups. This reaction occurred generally between 100 and 200° C. over a 0 to 24 hour reaction time. The resultant AFP was filtered and analyzed before further testing.

Aqueous dispersions were experimentally made by weighing the AFP in ajar and adding a 20% by weight excess of aqueous ammonia to give an overall system with a basic pH and 60% solids by weight. The AFPs are typically viscous and require heating to get them to disperse into the aqueous phase. These dispersions may be prepared using any means known or to be developed in the art; however, in preliminary experiments using this system difficulties in keeping the ammonia in the vessel while mixing the hot polyester and water were encountered. For that reason, the following procedure was developed, allowing preparation of the dispersions in a sealed jar so that the ammonia could not escape.

To prepare the dispersion by the “sealed jar” method, the following steps are preferred:

1. The acid functional polyol is weighed into ajar;

2. A solution of ammonia and water containing a sufficient ammonia to neutralize about 120% of the carboxylic acid is prepared;

3. Aqueous ammonia is added to the polyol at ambient temperature, resulting in a solution having overall solids of 60% by weight and properly neutralized acid groups;

4. The jar is sealed and heated to approximately 58° C.;

5. Under heat, the polyol and aqueous ammonia are mixed in the sealed jar by shaking or rolling; the sample is maintained at constant temperature until removed for testing.

6. Prior to testing, the jar is cooled to approximately 25° C. before opening;

7. Once opened, viscosity and pH are tested as quickly as possible before re-sealing.

All samples were run in duplicate, and the method showed good reproducibility. The pH measurements were made by diluting an aliquot of each dispersion with deionized water to 10% by weight. The viscosity was measured at 25° C. on the neat dispersion using a Brookfield viscometer.

In these experiments, four aspects each of the AFPs were listed. Molar ingredient ratios, functionality, acid numbers, hydroxyl numbers, and processing conditions were held constant throughout the testing regime.

The following Table 1 includes the shorthand abbreviations of the various materials, which will be used herein.

TABLE 1

| MATERIAL | ABBREVIATION |
|---|---|
| Polymeric diols: | |
| Polytetramethylene glycol- 140 hydroxyl number | PT140 |
| Polytetramethylene glycol- 177 hydroxyl number | PT180 |
| Polycarbonate polyol- 134 hydroxyl number | PCR |
| Polypropylene glycol- 178 hydroxyl number | PPG |
| Polycaprolactone- 135 hydroxyl number | PCL |
| 36-carbon dimer diol | DOL |
| Monomeric glycols: | |
| 1,6- Hexanedio | HD |
| 2,2-dimethyl-1,3-propanediol | NPG |
| Diethylene glycol | DEG |
| Ethylene glycol | EG |
| 2,2,4-trimethyl-1,3-pentanediol | TMPD |
| 2-butyl-2-ethyl-1,3-propanediol | BEPD |
| Hydroxypivalyl hydroxypivalate | HPHP |
| trimethylol propane | TMP |
| Diacids: | |
| Adipic acid | AA |
| Orthophthalic acid | OPA |
| Isophthalic acid | IPA |
| 1,4-cyclohexane diacid | CHDA |
| Hexanedioic acid | HDA |
| Anhydrides: | |
| Trimellitic anhydride | TMA |
| Pyromellitic dianhydride | PMDA |
| (2,5-dioxotetrahydrol)-3-methyl 3-cyclohexene 1,2- | BAN |
| dicarboxylic anhydride | |
| Hexahydrophthalic anhydride | HHPA |

Table 2 below shows each of the samples tested, the reagents from which they were formed, and their acid number and hydroxyl number.

TABLE 2

| AFP | | | | | |
|---|---|---|---|---|---|
| Sample | Diol(s) | Diacid | Anhydride | Acid | OH |
| Comp1 | Lexorez ® 4505-52 | | | 70.0 | 67.9 |
| Comp2 | Lexorez ® 1405-65 | | | 59 | 66.9 |
| 1 | BEPD | AA | BAN | 50.5 | 66.4 |
| 2 | BEPD | AA | PMDA | 51.6 | 60.3 |
| 3 | BEPD | AA | PMDA/TMA | 51.0 | 70 |
| 7 | HD/NPG/TMP | AA | HHPA | 53.3 | 74.3 |
| 16 | HPHP | AA | BAN | 55.3 | 71.7 |
| 17 | HPHP | AA | PMDA | 49.2 | 68.1 |
| 18 | HPHP | AA | PMDA/TMA | 50.0 | 66.8 |
| 19 | TMPD/TMP | AA | HHPA | 54.0 | 77.2 |
| 26 | TMPD | AA | BAN | 49.2 | 70 |
| 27 | TMPD | AA | PMDA | 54.7 | 72.9 |
| 28 | TMPD | AA | PMDA/TMA | 50.1 | 75.1 |
| 29 | HD/NPG | CHDA | BAN | 51.1 | 71.2 |
| 30 | HD/NPG | CHDA | PMDA | 50.6 | 73.8 |
| 31 | HD/NPG | CHDA | PMDA/TMA | 51.4 | 60.7 |
| 32 | TMPD | CHDA | BAN | 48.2 | 64 |
| 35 | HD/NPG | IPA | BAN | 39.6 | 44.6 |
| 36 | DEG | OPA | PMDA/TMA | 60 | 126 |

| | | | | |
|---|---|---|---|---|
| 40 | PCL | PMDA/TMA | 70.6 | 63.6 |
| 42 | PT140 | PMDA/TMA | 65.8 | 59.6 |
| 43 | PCR | PMDA/TMA | 54.5 | 54.0 |
| 44 | PPG | PMDA/TMA | 72 | 125 |
| 45 | PT180 | PMDA/TMA | 67 | 117 |
| 46 | DOL | PMDA/TMA | 34 | 117 |

Dispersions of the invention as described above were made and tested for initial dispersibility, viscosity, pH stability, and dispersion stability. In the first set of data, dispersions of AFPs of Comparative Example 2 (Comp2), and samples Nos. 28, 29, 30, 31, 32, and 35 were tested with 20% propylene glycol n-propyl ether as a co-solvent. The co-solvent was used to reduce viscosity of samples and in the dispersion step.

After moderate mixing, each AFP dispersion tested had a clear appearance. Initial pH and viscosity readings were recorded and the samples were placed in the oven for accelerated aging at approximately 58° C. Dispersion stability, viscosity, and pH were run on all samples as a function of time as shown below in Tables 3 and 4. In each of Tables 3 and 4, double underlining indicates that the sample was hazy in appearance and single underlining shading indicates phase separation of sample was observed.

TABLE 3

| Days | | | | | | | | |
|---|---|---|---|---|---|---|---|---|
| aged | | | | | | | | |
| at | pH of 10% aqueous solution | | | | | | | |
| 58° C. | Comp2 | 28 | 29 | 30 | 31 | 32 | 35 | Average |
| 0 | 9.12 | 9.42 | 9.18 | 9.12 | 9.11 | 9.02 | 9.11 | 9.15 |
| 13 | 6.87 | 8.59 | 8.46 | 7.78 | 8.07 | 8.56 | 8.19 | 8.06 |
| 28 | 5.79 | 7.99 | 7.92 | 6.73 | 7.13 | 8.22 | 7.67 | 7.37 |
| 42 | 5.25 | 7.24 | | | | | | |
| 57 | 4.60 | 6.74 | 6.83 | 5.56 | 5.83 | 7.30 | 6.88 | 6.25 |
| 71 | 4.39 | 6.41 | 6.61 | 5.31 | 5.55 | 7.03 | 6.75 | 6.01 |
| 86 | | 6.06 | 6.36 | | | 6.80 | 6.59 | 6.51 |
| 100 | | 5.82 | 6.20 | | | 6.72 | 6.54 | 6.39 |
| 112 | | | 6.06 | | | 6.56 | 6.39 | 6.33 |
| 127 | | | 5.62 | | | 6.50 | 6.33 | 6.15 |
| 141 | | | | | | 6.38 | 6.27 | 6.32 |

TABLE 4

| Days | | | | | | | | |
|---|---|---|---|---|---|---|---|---|
| aged | Viscosity retained (% of original viscosity at 25° C.) | | | | | | | |
| at | | | | | | | | Average |
| 58° | | | | | | | | viscosity |
| C. | Comp2 | 28 | 29 | 30 | 31 | 32 | 35 | retained |
| 0 | 100% | 100% | 100% | 100% | 100% | 100% | 100% | 100% |
| 13 | 62% | 74% | 58% | 71% | 71% | 79% | 53% | 66% |
| 28 | 41% | 63% | 44% | 70% | 73% | 62% | 30% | 55% |
| 42 | 10% | 57% | 24% | 53% | 59% | 26% | 7% | 34% |
| 57 | 5% | 52% | 9% | 32% | 46% | 8% | 3% | 22% |
| 71 | 10% | 47% | 6% | 8% | 19% | 4% | 3% | 14% |
| 86 | | 46% | 2% | | | 2% | 1% | 12% |
| 100 | | 18% | 1% | | | 1% | 0% | 5% |
| 112 | | | 1% | | | 1% | 1% | 1% |
| 127 | | | 1% | | | 1% | | 1% |
| 141 | | | | | | 1% | | 1% |

For all systems, it was found that three changes occurred during aging: (i) viscosity decreased (ii) pH decreased; and (iii) the system transitioned from a clear appearance to a hazy appearance to an apparent phase separation. The proposed mechanism to account for these changes the hydrolysis of the ester groups in the polymer backbone. Hydrolytic depolymerization also appears to lead to a decrease in viscosity, as is seen within the samples over time. The applicants have determined that the decrease in pH is caused by a loss of base (ammonia) and/or the generation of acid groups (through hydrolysis of the ester groups). Titration experiment demonstrate that both occur to some extent, but the consistency of duplicate samples shows that ammonia loss is similar from sample to sample therefore more of a constant. Further, the pH did not drop at the same rate for each AFP. The applicants concluded that, since it is highly unlikely that the variations in ammonia evaporation can be attributed to the differences in chemical structure among polymeric backbones, the rate of pH decline among samples is primarily attributable to the hydrolytic stability of the polymeric backbone. Thus, the rate of hydrolysis of the various AFPs can be indirectly determined by the amount of time necessary to degrade to specific pH values (8, 7, and 6).

As a general proposition, viscosity decreases rapidly until it reaches about 10% of the initial value. At this time, most samples were phase separated. There was no “break” in the pH graph at the time of phase separation; therefore it can be concluded that the rate of hydrolysis was not particularly sensitive to the morphology of a sample. pH at phase separation was measured to indicate the relative dispersion stability of each backbone. This information is provided below in Table 5, which also provides properties of the AFPs having differing backbones.

TABLE 5

| Days aged at 58° C. | Comp2 | 28 | 29 | 30 | 31 | 32 | 35 |
|---|---|---|---|---|---|---|---|
| Days to pH 8 | 6 | 31 | 26 | 11 | 14 | 36 | 18 |
| Days to pH 7 | 12 | 53 | 52 | 24 | 31 | 73 | 52 |
| Days to pH 6 | 24 | 88 | 113 | 46 | 53 | 141+ | 141+ |
| Days to 50% initial | 23 | 64 | 21 | 44 | 52 | 33 | 15 |
| viscosity | | | | | | | |
| Days to 10% initial | 57 | 106 | 57 | 70 | 77 | 56 | 40 |
| viscosity | | | | | | | |
| Days to hazy | 30 | 68 | 38 | 52 | 55 | 29 | 26 |
| appearance | | | | | | | |
| Days to phase | 36 | 72 | 46 | 64 | 64 | 35 | 46 |
| separation | | | | | | | |
| pH at phase separation | 5.4 | 6.5 | 7.2 | 5.4 | 5.7 | 7.8 | 7.0 |

Slow decreases in pH and viscosity and indicate resistance to hydrolysis. Comparative example 2 (Comp 2) has excellent dispersion stability (stable to a pH of 5.4), but relatively poor hydrolytic stability. The samples with good pH stability tended to be not as good with respect to dispersion stability, such that it is difficult to maximize both properties in the same sample, but the data did not indicate that different backbones were better at different things. In this experiment, all samples except 32 were better than the commercial comparative example, Comp 2, in amount of time to phase separation, which is the most important indicator.

### EXAMPLE 2

The samples of Example 2 were prepared similarly to those of Example 1, with the exception that the dispersions were prepared without solvent being added to the mixture. These systems were initially dispersible, and all hydrolyzed during aging at 58° C. Again, hydrolysis was measured by a decrease in viscosity and a decrease in pH, and eventually by visual observation (clear, hazy, or phase separated appearance). All samples showed the same directional change, but at different rates. Changes in pH, viscosity, and phase stability show that certain reaction mixture (RM) combinations are superior for enhanced performance in accordance with the present invention.

The following Table 6 lists the time (in days) for each system to reach pH values of 8, 7, and 6, for the onset of a hazy appearance and subsequent phase separation and for 50% and 90% reductions in viscosity. The pH at phase separation is also listed, as it gives an indication of the inherent ability of the backbone to disperse.

TABLE 6

| | | | | Days aged at 58° C. | | | | |
|---|---|---|---|---|---|---|---|---|
| | | | | to specified reduction | | Days aged at 58° C. | | |
| | Days aged at 58° C. | | | in viscosity | | until change in | | |
| AFP | to reach specified | | | 50% | 90% | visual observation | | pH value at |
| Sample | pH value | | | viscosity | viscosity | Hazy | Phase | phase |
| No. | pH 8 | pH 7 | pH 6 | reduction | reduction | appearance | separation | separation |
| Comp1 | 8 | 17 | 34 | 5 | 11 | 14 | 15 | 7.2 |
| Comp2 | 4 | 8 | 14 | 6 | 14 | 16 | 22 | 5.2 |
| 1 | 13 | 25 | 51 | 9 | 19 | 0 | 14 | 7.9 |
| 2 | 7 | 13 | 22 | 12 | 32 | 1 | 28 | 5.6 |
| 3 | 11 | 21 | 32 | 8 | 31 | 28 | 34 | 5.9 |
| 7 | 8 | 12 | 23 | 4 | 9 | 1 | 6 | 8.3 |
| 16 | 6 | 13 | 38 | 6 | 12 | 7 | 14 | 7.0 |
| 17 | 3 | 7 | 12 | 10 | 21 | 14 | 21 | 5.2 |
| 18 | 3 | 7 | 12 | 12 | 23 | 15 | 21 | 5.1 |
| 19 | 11 | 22 | 45 | 5 | 10 | 1 | 7 | 8.2 |
| 26 | 21 | 49 | — | 10 | 30 | 0 | 28 | 7.8 |
| 27 | 9 | 19 | 34 | 15 | 35 | 29 | 41 | 5.8 |
| 28 | 19 | 35 | 57 | 18 | 69 | 49 | 69 | 5.7 |
| 29 | 13 | 32 | 68 | 8 | 14 | 21 | 28 | 7.1 |
| 30 | 6 | 14 | 28 | 9 | 23 | 30 | 36 | 5.6 |
| 31 | 9 | 19 | 35 | 10 | 26 | 36 | 42 | 5.7 |

By comparing different products in the above test matrix and carefully examining the effect of different base polyol and anhydride components in those products, it can be determined that certain ingredients and combinations lead to desired improvements in dispersion stability. Use of the effect of the anhydride used is examined below in Table 7 including the same criteria noted above for testing in Table 6.

TABLE 7

| | | Number of days to: | | | | | | | |
|---|---|---|---|---|---|---|---|---|---|
| | | | | | 50% | 90% | | | pH value |
| | | | | | viscosity | viscosity | Hazy | Phase | at phase |
| Anhydride | ID | pH 8 | pH 7 | pH 6 | reduction | reduction | Appearance | Separation | separation |
| Comp1 | | 8 | 17 | 34 | 5 | 11 | 14 | 15 | 7.2 |
| Comp2 | | 4 | 8 | 14 | 6 | 14 | 16 | 22 | 5.2 |
| BAN | 1 | 13 | 25 | 51 | 9 | 19 | 0 | 14 | 7.9 |
| BAN | 16 | 6 | 13 | 38 | 6 | 12 | 7 | 14 | 7.0 |
| BAN | 29 | 13 | 32 | 68 | 8 | 14 | 21 | 28 | 7.1 |
| BAN | 26 | 21 | 49 | — | 10 | 30 | 0 | 28 | 7.8 |
| HHPA | 7 | 8 | 12 | 23 | 4 | 9 | 1 | 6 | 8.3 |
| HHPA | 19 | 11 | 22 | 45 | 5 | 10 | 1 | 7 | 8.2 |
| PMDA | 2 | 7 | 13 | 22 | 12 | 32 | 1 | 28 | 5.6 |
| PMDA | 17 | 3 | 7 | 12 | 10 | 21 | 14 | 21 | 5.2 |
| PMDA | 27 | 9 | 19 | 34 | 15 | 35 | 29 | 41 | 5.8 |
| PMDA | 30 | 6 | 14 | 28 | 9 | 23 | 30 | 36 | 5.6 |
| PMDA/TMA | 3 | 11 | 21 | 32 | 8 | 31 | 28 | 34 | 5.9 |
| PMDA/TMA | 18 | 3 | 7 | 12 | 12 | 23 | 15 | 21 | 5.1 |
| PMDA/TMA | 28 | 19 | 35 | 57 | 18 | 69 | 49 | 69 | 5.7 |
| PMDA/TMA | 31 | 9 | 19 | 35 | 10 | 26 | 36 | 42 | 5.7 |

From the data presented in this table, it is apparent that the aliphatic anhydrides and dianhydrides (HHPA and BAN) give outstanding pH stability, but the samples are less dispersion-stable because they phase separate at a relatively high pH. Samples based on aromatic anhydrides and dianhydrides (PMDA and TMA) show a more rapid rate of pH decline, but are stable at much lower pH values. Thus, depending on the end product desired aromatic anhydrides may be more beneficial for acquiring desired properties.

In the following Table 8, the effects of using different diacids to make base polyols for use in the invention are evaluated.

TABLE 8

| | | Number of days to: | | | | | | | |
|---|---|---|---|---|---|---|---|---|---|
| | | | | | 50% | 90% | | | pH value |
| | | | | | viscosity | viscosity | Hazy | Phase | at phase |
| Anhydride | ID | pH 8 | pH 7 | pH 6 | reduction | reduction | Appearance | Sep. | separation |
| Comp1 | | 8 | 17 | 34 | 5 | 11 | 14 | 15 | 7.2 |
| Comp2 | | 4 | 8 | 14 | 6 | 14 | 16 | 22 | 5.2 |
| AA | 1 | 13 | 25 | 51 | 9 | 19 | 0 | 14 | 7.9 |
| AA | 2 | 7 | 13 | 22 | 12 | 32 | 1 | 28 | 5.6 |
| AA | 3 | 11 | 21 | 32 | 8 | 31 | 28 | 34 | 5.9 |
| AA | 7 | 8 | 12 | 23 | 4 | 9 | 1 | 6 | 8.3 |
| AA | 16 | 6 | 13 | 38 | 6 | 12 | 7 | 14 | 7.0 |
| AA | 17 | 3 | 7 | 12 | 10 | 21 | 14 | 21 | 5.2 |
| AA | 18 | 3 | 7 | 12 | 12 | 23 | 15 | 21 | 5.1 |
| AA | 19 | 11 | 22 | 45 | 5 | 10 | 1 | 7 | 8.2 |
| AA | 26 | 21 | 49 | — | 10 | 30 | 0 | 28 | 7.8 |
| AA | 27 | 9 | 19 | 34 | 15 | 35 | 29 | 41 | 5.8 |
| AA | 28 | 19 | 35 | 57 | 18 | 69 | 49 | 69 | 5.7 |
| CHDA | 29 | 13 | 32 | 68 | 8 | 14 | 21 | 28 | 7.1 |
| CHDA | 30 | 6 | 14 | 28 | 9 | 23 | 30 | 36 | 5.6 |
| CHDA | 31 | 9 | 19 | 35 | 10 | 26 | 36 | 42 | 5.7 |

The data in Table 8 makes it apparent that the use of cycloaliphatic diacids in the base polyester polyol may give a better dispersion stability than corresponding samples made with linear aliphatic diacids. These have a slower rate of pH decline, yet remain stable to a low pH. In the following Table 9, the effect of the monomeric polyol used in the invention are evaluated.

TABLE 9

| | | Number of days to: | | | | | | | |
|---|---|---|---|---|---|---|---|---|---|
| | | | | | 50% | 90% | | | pH value |
| | | | | | viscosity | viscosity | Hazy | Phase | at phase |
| Polyol | ID | pH 8 | pH 7 | pH 6 | reduction | reduction | appearance | Separation | separation |
| Comp1 | | 8 | 17 | 34 | 5 | 11 | 14 | 15 | 7.2 |
| Comp2 | | 4 | 8 | 14 | 6 | 14 | 16 | 22 | 5.2 |
| HPHP | 16 | 6 | 13 | 38 | 6 | 12 | 7 | 14 | 7.0 |
| HPHP | 17 | 3 | 7 | 12 | 10 | 21 | 14 | 21 | 5.2 |
| HPHP | 18 | 3 | 7 | 12 | 12 | 23 | 15 | 21 | 5.1 |
| BEPD | 1 | 13 | 25 | 51 | 9 | 19 | 0 | 14 | 7.9 |
| BEPD | 2 | 7 | 13 | 22 | 12 | 32 | 1 | 28 | 5.6 |
| BEPD | 3 | 11 | 21 | 32 | 8 | 31 | 28 | 34 | 5.9 |
| HD/NPG | 29 | 13 | 32 | 68 | 8 | 14 | 21 | 28 | 7.1 |
| HD/NPG | 30 | 6 | 14 | 28 | 9 | 23 | 30 | 36 | 5.6 |
| HD/NPG | 31 | 9 | 19 | 35 | 10 | 26 | 36 | 42 | 5.7 |
| HD/NPG/TMP | 7 | 8 | 12 | 23 | 4 | 9 | 1 | 6 | 8.3 |
| TMPD/TMP | 19 | 11 | 22 | 45 | 5 | 10 | 1 | 7 | 8.2 |
| TMPD | 26 | 21 | 49 | | 10 | 30 | 0 | 28 | 7.8 |
| TMPD | 27 | 9 | 19 | 34 | 15 | 35 | 29 | 41 | 5.8 |
| TMPD | 28 | 19 | 35 | 57 | 18 | 69 | 49 | 69 | 5.7 |

From Table 9, it appears that a system with secondary hydroxyl groups (TMPD) outperformed those with only primary hydroxyls. HPHP system performed essentially identical to comparative commercial examples Comp 1 and Comp 2, and BEPD performed only slightly better because it had a moderately slower rate of pH decline. The HD/NPG samples showed good performance, but the particular samples above were made with a different diacid that may be improving the sample more than the polyol moiety (see Table 8). The overall effect is that secondary hydroxyls in the base polyol may be preferred over similar systems that contain only primary hydroxyl groups, depending on the specific properties desired in the final AFP.

The second experiment showed that overall benefits to dispersion stability can be obtained by individually varying the components in an ester base polyol. In particular, it is preferred that the mono- or polyanhydride should be aromatic, the polyester glycol component should possess some secondary hydroxyl character, and the polyester diacid should be cycloaliphatic. As these are benefits attributed to the individual components of a composite system, it is expected that combinations of these beneficial species will be used to optimize the value of the overall system. Therefore, the system preferably should include at least one but preferably two or more of the individual beneficial species to give an overall acid functional polyol with improved long term dispersion stability.

### EXAMPLE 3

In this test, the dispersion stability properties of several AFPs that were made using different types of base polyols are compared. AFP sample Nos. 42, 43, 44, 45 and 46 were made with base polyols that had no ester bonds, and therefore the backbone was expected to show little tendency to hydrolyze. Despite this, the pH and viscosity still dropped over time, and some systems did not form a stable dispersion, or phase separated after a relatively short time. The most likely cause was hydrolysis of the ester bond that was formed when reacting the anhydride with the base polyol, rather than the hydrolysis of bonds within the base polyol itself. This shows that merely providing a hydrolytically stable base polyol is not sufficient to improve the hydrolytic resistance and dispersion stability of the AFPs. The data is shown below in Table 10.

TABLE 10

| Aged at 54° C. | Comp2 | 36 | 40 | 42 | 43 | 44 | 45 | 46 |
|---|---|---|---|---|---|---|---|---|
| Days to pH 8 | 3 | 0 | 2 | 4 | 1 | 2 | 5 | — |
| Days to pH 7 | 10 | 0 | 6 | 13 | 11 | 6 | 15 | — |
| Days to pH 6 | 21 | 3 | 11 | 32 | 32 | 11 | 35 | — |
| Days-50% initial | 11 | 0 | 6 | 45 | 15 | 53 | 52 | 6 |
| viscosity | | | | | | | | |
| Days-10% initial | 25 | 6 | 11 | 64 | 27 | 64 | 64 | 11 |
| viscosity | | | | | | | | |
| Days to haze | 25 | 1 | 25 | 39 | 0 | 0 | 14 | — |
| Days to phase | 35 | 6 | 33 | 48 | 56 | 13 | 25 | 0 |
| separation | | | | | | | | |
| pH at phase separation | 5.14 | 5.69 | 5.44 | 5.59 | 5.36 | 5.65 | 6.54 | 9.65 |

The above data and Examples demonstrate that the applicants have developed a combination of preferred base polyols and anhydrides that provide dispersion-stable and hydrolysis resistant AFPs for use in water-borne dispersions and dispersions formed using the same.

The following Examples 5 to 8 demonstrate the efficacy of the dispersion-stable AFPs of the present invention when incorporated into personal care formulations, such as cosmetics and personal hygiene products, and industrial lubricants. It is noted, however that the Examples are not all inclusive of the various combinations and permutations of components that are contemplated within the scope of the invention. It should understood that, based upon this disclosure and use of known formulation techniques and ingredients, as well as those to be developed, a wide variety of similar products not specifically detailed here can be formulated.

### EXAMPLE 5

### Alcohol-Free Styling Product (Water Based)

A water-based hair styling product was formulated using the AFP's of the present invention by combining the following components in the following quantities (Table 11):

TABLE 11

| | Quantity |
|---|---|
| | (percent by weight of the total |
| Component | composition) |
| AFP Sample No. 28 | 9.00 |
| Aminomethylpropanol | 0.80 |
| Lauryl diethanolamide | 0.15 |
| Glycerin | 0.10 |
| Dimethicone | 0.30 |
| Methylparaben | 0.20 |
| Propylparaben | 0.10 |
| Deionized Water | QS to 100 |

The pH of the resultant product was 8.12 and the viscosity (24 hours; Brookfield RVT; RV-2@100 rpm) was 28 cPs. The product was stable to six freeze/thaw cycles and three months at 45° C. Thus, the AFPs of the present invention are useful as a primary emulsifier in water-based hair styling products, providing film-forming and conditioning effects, but avoiding the use of alcohol or other organic solvents and the potential medical, commercial, and environmental problems associated with such solvents.

As in known in the formulation art, the above exemplary formulation can be modified to prepare specific water-based hair styling products, such as hair spray, hair mousse, hair gel, etc., using conventional techniques.

### EXAMPLE 6

### Surfactant System For Use in the Formulation of Water-Based Bath Gels/Shampoos, etc.

A water-based surfactant system was formulated using the AFP's of the present invention by combining the following components in the following quantities (Table 12):

TABLE 12

| | Quantity |
|---|---|
| | (percent by weight of the total |
| Component | composition) |
| Sodium Laureth Sulfate | 25.00 |
| Cocamidopropyl Betaine | 10.00 |
| Cocamide DEA | 3.00 |
| Propylene Glycol | 3.00 |
| Methylparaben | 0.20 |
| Propylparaben | 0.10 |
| Tetrasodium EDTA | 0.10 |
| AFP Sample No. 28 | 4.00 |
| Aminomethylpropanol | 0.35 |
| Behenamidopropyl PG Dimonium | 7.00 |
| Chloride | |
| Deionized Water | QS to 100 |

The pH of the finished product was 8.66 and the viscosity (24 hours; Brookfield RVT; RV-2@100 rpm) was 360 cPs. The product was stable to six freeze/thaw cycles and two months at 45° C. Thus, the AFPs of the present invention are useful as a primary emulsifier in water-based hair styling products, providing film-forming and conditioning effects, but avoid the use of alcohol or other organic solvents and the potential medical, commercial, and environmental problems associated with such solvents.

As in known in the formulation art, this surfactant system could be modified to prepare specific water-based personal care cleansing products using conventional techniques, for example, hair and body shampoos, scrubs, facial cleansers, bath/shower gels, and dishwashing liquids. These products can be formulated so that the AFPs (polymeric esters) remain on the skin or hair to provide extended conditioning, softening, and moisturizing benefits, to provide barrier properties, improve skin feel and to provided other sensory benefits.

### EXAMPLE 7

### Water-Based Low Viscosity Moisturizing Lotion Formulation

A formulation for a low viscosity moisturizing lotion is provided below. In order to formulate the lotion, a first, and a second phase are prepared containing the components as set forth below (where phase 1 is Table 13 and phase 2 is Table 14):

TABLE 13

| | Quantity |
|---|---|
| | (percent by weight of the total |
| Phase 1 Component | composition) |
| Deionized water | 82.60 |
| Methyl paraben | 0.15 |
| Propyl paraben | 0.05 |
| Behenamidopropyl PG Dimonium | 0.20 |
| Chloride | |
| Propylene glycol | 2.00 |

TABLE 14

| | Quantity |
|---|---|
| | (percent by weight of the total |
| Phase 2 Component | composition) |
| LEXEMUL ® CS-20 | 4.00 |
| LEXATE ® TA | 7.00 |
| AFP Sample No. 8 | 4.00 |

LEXEMUL®t CS-20 and LEXATE® TA are each available from Inolex Chemical Corporation, Philadelphia, Pa., U.S.A.

Phase 1 is combined with phase 2, after which triethanolamine is added to the entire formulation in a sufficient quantity to adjust the final pH to approximately 7. The finished product had a viscosity (24 hours; Brookfield RVT; spindle T-A @ 100 rpm) of 3280 cPs. The product was stable to six freeze/thaw cycles and three months at 45° C.

### EXAMPLE 8

### Water-Based High Viscosity Moisturizing Lotion

A formulation for a low viscosity moisturizing lotion is provided below. In order to formulate the lotion, a first and a second phase are prepared containing the components as set forth below (where Phase 1 is Table 15 and phase 2 is Table 16):

TABLE 15

| | Quantity |
|---|---|
| | (percent by weight of the total |
| Phase 1 Component | composition) |
| Deionized water | 70.90 |
| Propylene glycol, USP | 3.00 |
| Methyl paraben | 0.20 |
| Tetrasodium | 0.10 |
| ethylenediaminetetraacetate | |
| Propyl paraben | 0.10 |

TABLE 16

| | Quantity |
|---|---|
| | (percent by weight of the total |
| Phase 2 Component | composition) |
| Octyl methoxycinnate | 7.50 |
| Oxybenzone | 4.50 |
| AFP Sample No. 28 | 4.00 |
| LEXEMUL ® CS-20 | 0.30 |
| Glyceryl stearate | 1.00 |
| Octyl Palmate | 1.00 |
| Octyl salicylate | 5.00 |
| Aluminum starch | 2.00 |
| octenylsuccinate | |
| Acrylates/C10-30 Alkyl Acrylate | 0.40 |
| crosspolymer | |

LEXEMUL ® CS-20 is available from Inolex Chemical Corporation, Philadelphia, Pennsylvania, U.S.A.

Phase 1 is combined with phase 2, after which triethanolamine is added to the entire formulation in a sufficient quantity to adjust the final pH to approximately 7. The finished product had a viscosity (72 hours; Brookfield RVT; spindle T-C @100 rpm) of 73,250 cPs. The product was stable to six freeze/thaw cycles and three months at 45° C.

### EXAMPLE 9

### Industrial Lubricant Formulation

Dispersion-stable AFPs in accordance with the present invention can be used in the preparation of industrial lubricants for use in a variety of applications, including for example, lubricants used in metalworking. Shown below, is a comparison of the aqueous dispersion and lubrication properties of AFP Sample No. 28 and Comp 2 with those of two other prior art esters that are presently used in metalworking fluids.

The first such ester is isopropyl oleate (comparative SE1), a monoester that is considered to be hydrolytically stable. The second is a polymeric ester (comparative CE 1) made from 2-Ethyl-2-(hydroxymethyl)-1,3-propanediol, hexanedioic acid, and oleic acid reacted to an approximate viscosity of 500 cSt at 100° C.

The formulation used in this example, in which each of the AFP and the comparative polymers was incorporated was a simple aqueous dispersion consisting only of the ester to be tested, a neutralizing amine and water. No added emulsifiers were incorporated in order to demonstrate the dual usefulness of the AFP of the present invention as an emulsifier with the further benefits of lubrication found in the comparative esters. Table 17 below shows the results obtained when this simple aqueous dispersion was subjected to lubricity testing (Falex test) using a Falex pin and vee block machine in accordance with procedures known in the art for the evaluation of wear properties of fluid lubricants (ASTM No. D-2670, 2001).

TABLE 17

| Run | | | Falex failure | Dispersion |
|---|---|---|---|---|
| No. | Ester at 5% | Amine at 1% | load (lbs) | appearance |
| 1 | SE1 | triethylamine | 300 | two phase* |
| 2 | CE1 | triethylamine | 300 | two phase* |
| 3 | 28 | triethylamine | 1250 | clear-slightly hazy |
| 4 | 28 | triethanolamine | 1250 | clear-slightly hazy |
| 5 | 28 | ammonia | 1000 | clear-slightly hazy |
| 6 | Comp 2 | triethylamine | 1500 | Clear |
| 7 | Comp 2 | triethanolamine | 750 | Clear |
| 8 | Comp 2 | ammonia | 1000 | Clear |

*tested bulk aqueous phase

The above table shows that both acid functional polyesters could be neutralized with an amine and dispersed to give an aqueous dispersion that has good lubricating properties. The non-acid functional polyesters cannot be dispersed without an external emulsifier, and therefore are not useful as lubricants in this test. The ester molecules did not disperse into the water, so essentially only water was present to lubricate the metal surfaces.

Having demonstrated that the acid functional polyesters show lubrication and self emulsification benefits, the following Table 18 shows the pH and appearance of the dispersions as they were aged over several weeks. The samples in the table below are the same ones subjected to lubrication testing above. They were stored in an oven at 58° C. over the course of the procedure, and removed weekly to test the pH to observe the appearance of the dispersion.

TABLE 18

| AFP | | | | | | |
|---|---|---|---|---|---|---|
| Sample | | | | | | |
| No. | | | | | | |
| AMINE | 28 | Comp2 | 28 | Comp2 | | |
| Days at | triethanol- | triethanol- | triethyl- | triethyl- | 28 | Comp2 |
| 58° C. | amine | amine | amine | amine | Ammonia | Ammonia |
| 0 | 7.90 | 7.61 | 11.35 | 10.87 | 10.72 | 10.54 |
| 6 | 7.56 | 6.99 | 10.21 | 7.36 | 10.02 | 9.67 |
| 13 | 7.71 | 6.79 | 10.23 | 6.52 | 10.28 | 9.56 |
| 20 | 7.31 | 6.1 | 9.58 | 5.83 | 9.83 | 9.40 |
| 27 | 7.18 | 5.58 | 9.19 | 5.43 | 9.77 | 9.31 |
| 34 | 7.09 | 5.05 | 9.02 | 5.08 | 9.99 | 9.47 |
| 41 | 6.95 | 4.71 | 8.54 | 4.87 | 9.96 | 9.41 |

Double underlining indicates that the sample was hazy.

The above table shows that the dispersions made from AFP 28 and Comp2 each decreased in pH over time as hydrolysis of the ester bonds generated carboxylic acid groups. However, the pH of the dispersions made from AFP 28 changed at a much slower rate than those based on Comp2. This is an indication that AFP 28 is more resistant to hydrolysis than Comp2. Further, the samples of Comp2 neutralized with ammonia and triethylamine became hazy after 20 and 27 days respectively, while the sample of 28 neutralized with ammonia became hazy after 41 days and with triethylamine was still clear at the end of the test. Samples become hazy as the dispersion begins to become unstable. Therefore, both the pH and appearance data demonstrate that acid functional polyesters made from aromatic anhydrides and base polyols with a secondary hydroxyl group give more stable lubricant dispersions than currently available acid functional polyesters such as Comp2, yet are useful as industrial lubricants.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A dispersion-stable polymeric acid functional polyol that is a reaction product of a reaction mixture comprising
a base polyol having at least one of a terminal secondary or tertiary hydroxyl group, and
an aromatic anhydride, wherein the polymeric acid functional polyol exhibits improved dispersion stability and is resistant to hydrolysis.

2. The dispersion-stable polymeric acid functional polyol according to claim 1, wherein the base polyol has a terminal secondary hydroxyl group.

3. The dispersion-stable polymeric acid functional polyol according to claim 1, wherein the base polyol has the formula:
HO—C(R¹)ₙ(R²)ₘR³OH (I)
wherein R¹ is a hydrogen atom; R² is selected from the group consisting of substituted and unsubstituted branched and straight chain aliphatic alkyl and alkoxy groups of from 1 to 20 carbon atoms, substituted and unsubstituted cycloaliphatic groups, substituted and unsubstituted aryl groups, and substituted and unsubstituted aralkyl groups; R³ is selected from the group consisting of substituted and unsubstituted aliphatic alkyl or alkoxy groups of from 1 to 20 carbon atoms, cycloaliphatic groups, polymeric ethers, polymeric esters, polycarbonate, and polymeric ether esters; n is 0 or 1; m is 1 or 2.

4. The dispersion-stable polymeric acid functional polyol according to claim 3, wherein substituted R² or R³ may be substituted with at least one moiety selected from the group consisting halogen, carbamate, amine, lower alkyl, carboxylic acid, and hydroxyl.

5. The dispersion-stable polymeric acid functional polyol according to claim 3, wherein the base polyol is selected from the group consisting of propylene glycol, polypropylene glycol, 1,3-butanediol, 2,2,4-trimethyl-1,3-pentanediol, and ester polyols that are a reaction product of at least one polyol having a terminal secondary or tertiary hydroxyl group and a primary polyol, and/or at least one of a mono- or polycarboxylic acid and a mono- and polycarboxylic anhydride.

6. The dispersion-stable polymeric acid functional polyol according to claim 5, wherein the at least one mono- or polycarboxylic acid or mono- or polycarboxylic anhydride is hexanedioic acid.

7. The dispersion-stable polymeric acid functional polyol according to claim 6, wherein the at least one polyol is selected from the group consisting of propylene glycol, dipropylene glycol, 1,3 butanediol, and 2,2,4- trimethyl-1,3 pentanediol.

8. The dispersion-stable polymeric acid functional polyol according to claim 1, wherein the base polyol is a polyester polyol formed from a reaction of at least one diacid and at least one monomeric or oligomeric diol.

9. The dispersion-stable polymeric acid functional polyol according to claim 8, wherein the at least one diacid is a cycloaliphatic diacid.

10. The dispersion-stable polymeric acid functional polyol according to claim 8, wherein the at least one diacid is hexanedioic acid.

11. The dispersion-stable polymeric acid functional polyol according to claim 8, wherein the at least one monomeric or oligomeric diol is selected from the group consisting of propylene glycol, dipropylene glycol, 1,3 butanediol, and 2,2,4-trimethyl-1,3 pentanediol.

12. The dispersion-stable polymeric acid functional polyol according to claim 1, wherein the base polyol has a hydroxyl number of about 50 to about 1000 and a hydroxyl functionality of about 1 to about 5.

13. The dispersion-stable polymeric acid functional polyol according to claim 1, wherein the base polyol has a hydroxyl number of about 60 to about 200 and a hydroxyl functionality of about 2.

14. The dispersion-stable polymeric acid functional polyol according to claim 1, wherein the aromatic anhydride is a polyanhydride.

15. The dispersion-stable polymeric acid functional polyol according to claim 1, wherein the aromatic anhydride is selected from the group consisting of trimellitic anhydride, pyromellitic dianhydride, and phthalic anhydride.

16. The dispersion-stable polymeric acid functional polyol according to claim 1, wherein the dispersion-stable polymeric acid functional polyol has an acid number of about 5 to about 200 and a hydroxyl number of about 10 to about 300.

17. The dispersion-stable polymeric acid functional polyol according to claim 1, wherein the dispersion-stable polymeric acid functional polyol has an acid number of about 10 to about 100 and a hydroxyl number of about 10 to about 200.

18. A storage stable acid functional polyol dispersion, comprising an acid functional polymeric polyol which is a reaction product of a reaction mixture comprising a base polyol having at least one of a terminal secondary or tertiary hydroxyl group and an aromatic anhydride, wherein the acid functional polymeric polyol is dispersed by neutralizing at least one pendant carboxylic acid functional group on the acid functional polymeric polyol.

19. The storage stable acid functional polyol dispersion according to claim 18, wherein the aromatic anhydride is a polyanhydride.

20. The storage stable acid functional polyol dispersion according to claim 18, wherein the pendant carboxylic acid functional group is neutralized by an organic or an inorganic amine.

21. The storage stable acid functional polyol dispersion according to claim 20, wherein the amine is ammonia.

22. The storage stable acid functional polyol dispersion according to claim 18, further comprising at least one additive selected from the group consisting of catalysts, UV curing agents, colorants, thixotropic agents, pigments, leveling agents, corrosion inhibitors, emollients, odorants, dyes, biocides, fungicides, surfactants, monomers, oligomers, and UV stabilizers.

23. A solid polymeric material formed from a curing reaction of an acid functional polymeric polyol, wherein the acid functional polyol is the reaction product of a reaction mixture comprising a base polyol having at least one of a terminal secondary or tertiary hydroxyl group and an aromatic anhydride.

24. The solid polymeric material according to claim 23, wherein the curing reaction is a radiation cure or a reaction of the acid functional polyol and a curative, wherein the curative is at least one selected from the group consisting of an isocyanate and an amine.

25. The solid polymeric material according to claim 23, wherein the aromatic anhydride is a polyanhydride.

26. A method for improving the long term storage dispersibility and hydrolytic resistance of an acid functional polyol, the method comprising forming the acid functional polyol from the reaction of a base polyol having at least one of a terminal secondary or tertiary hydroxyl group and an aromatic anhydride.

27. The method according to claim 26, wherein the aromatic anhydride is a polyanhydride.

28. A method for making a water-borne polyurethane comprising reacting of a polyisocyanate and an acid functional polyol dispersion, wherein the dispersion comprises an acid functional polyol formed from the reaction of a base polyol having at least one of a terminal secondary or tertiary hydroxyl group with an aromatic anhydride.

29. The method according to claim 28, wherein the aromatic anhydride is a polyanhydride.

30. A formulation comprising a dispersion-stable polymeric acid functional polyol, wherein the dispersion-stable polymeric acid functional polyol is formed from a reaction of a base polyol having at least one of a terminal secondary or tertiary hydroxyl group and an aromatic anhydride.

31. The formulation of claim 30, wherein the base polyol has a terminal secondary hydroxyl group.

32. The formulation according to claim 30, wherein the aromatic anhydride is a polyanhydride.

33. The formulation of claim 30, wherein the formulation further comprises an additive selected from the group consisting of water, amines or other neutralizing agents, acids, performance additives, antioxidants, and biocides.

34. The formulation of claim 30, wherein the formulation further comprises an additive selected from the group consisting of fungicides, colorants, odorants, lubricant oils, silicones, emulsifiers, and defoamers.

35. The formulation of claim 30, wherein the formulation is a personal care formulation.

36. The formulation of claim 30, wherein the formulation is a lubricant formulation.

37. The formulation according to claim 36, wherein the lubricant formulation is adapted for use in a machining process, wherein the machining process is selected from the group consisting of a metal machining process, a ceramic machining process, a glass machining process, a wood machining process, and a polymer machining process.

38. The formulation according to claim 37, wherein the metal machining process is selected from the group consisting of an aluminum machining processes and a ferrous metal machining process.
